(19) United States
(12) Patent Application Publication
(10) Pub. No.: US 2013/0156394 A1
(43) Pub. Date: Jun. 20, 2013

(54) OPTICAL COMMUNICATION MODULE AND METHOD OF MANUFACTURING THE SAME

(71) Applicants: Joong-Seon CHOE, Daejeon (KR); Jong-Hoi Kim, Daejeon (KR); Kwang-Seong Choi, Daejeon (KR); Chun Ju Youn, Daejeon (KR); Duk Jun Kim, Daejeon (KR); Yong-Hwan Kwon, Daejeon (KR); Eun Soo Nam, Daejeon (KR)

(72) Inventors: Joong-Seon CHOE, Daejeon (KR); Jong-Hoi Kim, Daejeon (KR); Kwang-Seong Choi, Daejeon (KR); Chun Ju Youn, Daejeon (KR); Duk Jun Kim, Daejeon (KR); Yong-Hwan Kwon, Daejeon (KR); Eun Soo Nam, Daejeon (KR)

(73) Assignee: ELECTRONICS AND TELECOMMUNICATIONS RESEARCH INSTITUTE, Daejeon (KR)

(21) Appl. No.: 13/611,119

(22) Filed: Sep. 12, 2012

(30) Foreign Application Priority Data
Dec. 20, 2011 (KR) 10-2011-0138237

(51) Int. Cl. G02B 6/10; B32B 37/14

(52) U.S. Cl. 385/129; 156/60

(57) ABSTRACT

The inventive concept relates to an optical communication module. The optical communication module may include a metal block: an electrical device formed on the metal block; an optical device adhesive block formed on the metal block; an optical device formed on the optical device adhesive block and connected to the electrical device through a bonding interconnection; and a flat type optical waveguide formed on one side of the optical device adhesive block and optically aligned with the optical device.

### CROSS-REFERENCE TO RELATED APPLICATIONS

This U.S. non-provisional patent application claims priority under 35 U.S.C. §119 of Korean Patent Application No. 10-2011-0138237, filed on Dec. 20, 2011, the entire contents of which are hereby incorporated by reference.

### BACKGROUND

The present inventive concept herein relates to optical communications and methods of manufacturing the same.

As an optical communication technology has been highly developed, an optical communication module having a new function is being introduced. Referring to an example of receiver module, an optical receiver using a conventional single device includes one optical diode and is used to detect on and off of optical signal. An optical communication module such as a balanced optical receiver connecting a pair of optical diodes to detect a difference between the two optical signals and an optical module (for example, coherent optical receiver) in which two or four pairs of optical diodes are packaged with an optical hybrid is being developed these days. The above optical communication module is used to demodulate a signal of dual polarization orthogonal state phase modulation or a signal of coherent optical orthogonal frequency division multiplexing modulation.

In an optical communication module, optical fibers are optical-combined with optical diodes. The optical fibers may have an array form or may be put on a silicon optical bench (SiOB) to have a fixed form. An optical fiber array is fixed to an optical communication module by a laser welding after an optical alignment. When the silicon optical bench (SiOB) is used, the optical fibers may be fixed to the silicon optical bench (SiOB) by an epoxy, etc. after an optical alignment. A laser welding for fixing an optical fiber array has high reliability but has a disadvantage that a process apparatus is expensive and a process has a high level of difficulty.

### SUMMARY

Embodiments of the inventive concept provide an optical communication module. The optical communication module may include a metal block: an electrical device formed on the metal block; an optical device adhesive block formed on the metal block; an optical device formed on the optical device adhesive block and connected to the electrical device through a bonding interconnection; and a flat type optical waveguide formed on one side of the optical device adhesive block and optically aligned with the optical device.

Embodiments of the inventive concept also provide a method of manufacturing an optical communication module. The method may include forming a metal block having a stair structure including a first top surface and a second top surface lower than the first top surface; forming an optical device adhesive block on the second top surface of the metal block; attaching an electrical device on the first top surface of the metal block; attaching a waveguide type optical device on the top surface of the optical device adhesive block; connecting the electrical device and the waveguide type optical device to each other using a bonding interconnection; and attaching a flat type optical waveguide on one side of the optical device adhesive block. The flat type optical waveguide is optically aligned with a waveguide of the waveguide type optical device.

### BRIEF DESCRIPTION OF THE FIGURES

Preferred embodiments of the inventive concept will be described below in more detail with reference to the accompanying drawings. The embodiments of the inventive concept may, however, be embodied in different forms and should not be constructed as limited to the embodiments set forth herein. Rather, these embodiments are provided so that this disclosure will be thorough and complete, and will fully convey the scope of the inventive concept to those skilled in the art. Like numbers refer to like elements throughout.

FIG. 1 illustrates an optical communication module in accordance with a first illustration that a flat type optical waveguide, an optical device and an electrical device are combined with one another.

FIG. 2 illustrates an optical communication module in accordance with a second illustration that a flat type optical waveguide, an optical device and an electrical device are combined with one another.

FIG. 3 illustrates an optical communication module in accordance with a third illustration that a flat type optical waveguide, an optical device and an electrical device are combined with one another.

FIG. 4 illustrates thermal expansion coefficients of illustrative materials.

FIG. 5 illustrates a result obtained by measuring a photocurrent of balanced optical receiver including an optical fiber array made by fixing an optical fiber to a silicon optical bench before and after a temperature test is performed.

FIG. 6 is an optical communication module in accordance with a first embodiment of the inventive concept.

FIG. 7 is an optical communication module in accordance with a second embodiment of the inventive concept.

FIG. 8 is an optical communication module in accordance with a third embodiment of the inventive concept.

FIG. 9 is a flowchart illustrating a manufacturing method of optical communication module in accordance with some embodiments of the inventive concept.

### DETAILED DESCRIPTION OF THE EMBODIMENTS

Embodiments of inventive concepts will be described more fully hereinafter with reference to the accompanying drawings, in which embodiments of the invention are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

An optical communication module is used in various fields of optical communication. An optical communication module may be an optical hybrid including an optical device and an electrical device. In an optical communication module, an optical signal can be transmitted to an optical device through an optical waveguide combined with the optical device. An optical device converts an optical signal into an electrical signal and the converted electrical signal can be transmitted to an electrical device through interconnection lines.

An optical communication module may be manufactured by combining an optical waveguide manufactured in the form of a planar light wave circuit (PLC) with an optical device. An optical communication module may be manufactured by combining an optical waveguide manufactured in the form of silicon optical bench (SiOB) with an optical device. The optical waveguide manufactured in the form of a planar light wave circuit (PLC) and the optical waveguide manufactured in the form of silicon optical bench (SiOB) are called a flat type optical waveguide.

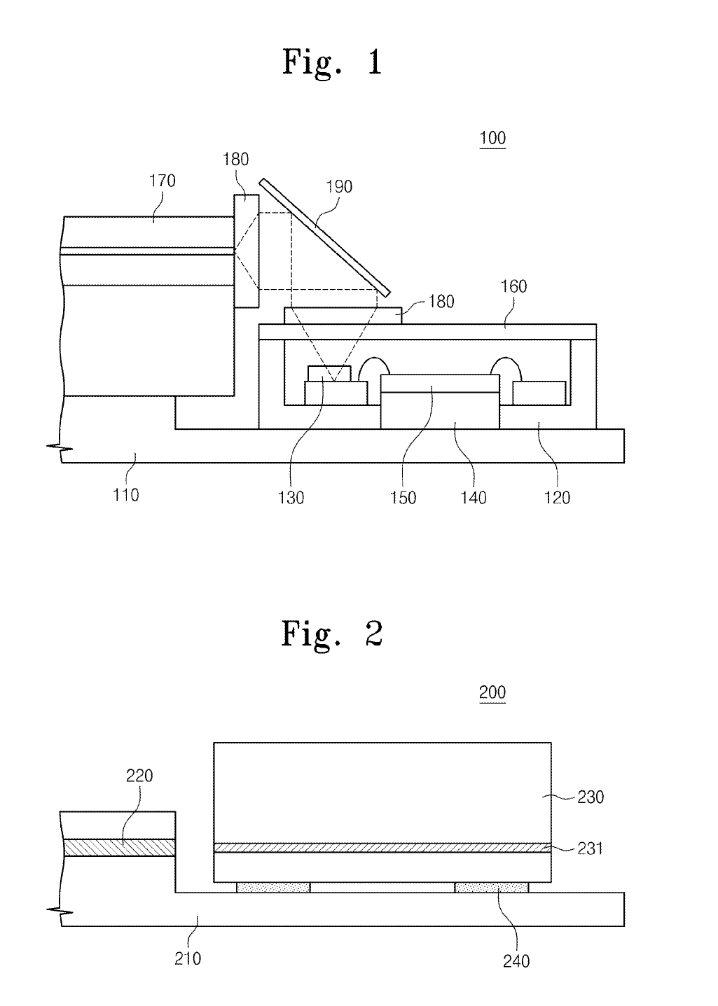

FIG. 1 illustrates an optical communication module 100 in accordance with a first illustration that a flat type optical waveguide, an optical device and an electrical device are combined with one another. Referring to FIG. 1, the optical communication module 100 includes a metal package 110, a ceramic package 120, an optical device 130, a heat sink 140, an electrical device 150, a window 160, a flat type optical waveguide 170, lenses 180 and a mirror 190.

The metal package 110 may be a housing wrapping the optical communication module 100. The ceramic package 120 may be a housing wrapping the optical device 130 and the electrical device 150 together with the window 160.

The optical device 130 receives an optical signal and can convert the received optical signal into an electrical signal. The optical device 130 may include a photodiode. The electrical signal converted by the optical device 130 can be transmitted to the electrical device 150 through interconnection lines. The heat sink 140 can maintain a temperature of the optical device 130 or the electrical device 150. The electrical device 150 receives an electrical signal from the optical device 130 through interconnection lines and can process the electrical signal.

The flat type optical waveguide 170 can guide an optical signal. The guided signal through the flat type optical waveguide 170 may be transmitted to the optical device 130 through the lens 180 and the mirror 190.

The optical communication module 100 reflects the guided optical signal using a minor and controls the guided optical signal using a lens. When an optical signal is propagated through the atmosphere, refracted in the lenses 180 and reflected in the mirror 190, a loss of optical signal may occur. Since constituent elements such as the lenses 180 and the minor 190 are needed and the constituent elements should be optically aligned, the manufacturing cost of the optical communication module 100 may rise.

FIG. 2 illustrates an optical communication module 200 in accordance with a second illustration that a flat type optical waveguide, an optical device and an electrical device are combined with one another. Referring to FIG. 2, the optical communication module 200 includes a flat type optical waveguide 210, an optical device 230 and a solder 240.

The optical waveguide 210 includes an optical waveguide core 220 guiding an optical signal. A part of the flat type optical waveguide 210 is etched and the optical device may be formed on the etched part of the flat type optical waveguide 210. The optical device 230 may include a waveguide type optical device having an optical waveguide 231. The optical waveguide 231 of the optical device 230 may be aligned with the optical waveguide core 220 of the flat type optical waveguide 210. That is, an optical signal guided through the optical waveguide core 220 of the flat type optical waveguide 210 can be transmitted to the optical waveguide 231 of the optical device 230. The solder 240 can fix the optical device 230 and the flat type optical waveguide 210.

In the flat type optical waveguide 210 manufactured by silica, the optical waveguide core 220 is located 20 um below a top surface of the flat type optical waveguide 210. Thus, the flat type optical waveguide 210 should be etched by 20 um or more to form the optical device 230 on the flat type optical waveguide 210 and optically combine the optical device 230 with the flat type optical waveguide 210. An etching depth should be precisely set considering an alignment error of the optical device 230. However, since it is difficult to maintain an etching error/deviation below a reference value while etching the flat type optical waveguide 210 by 20 um or more, it is difficult that an optical alignment is normally performed and it is difficult to secure a high yield.

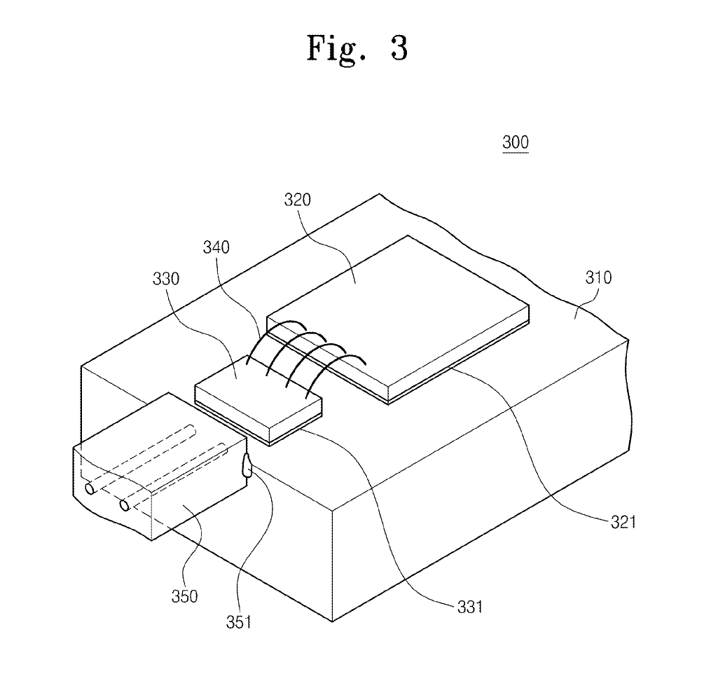

FIG. 3 illustrates an optical communication module 300 in accordance with a third illustration that a flat type optical waveguide, an optical device and an electrical device are combined with one another. Referring to FIG. 3, the optical communication module 300 includes a metal block 310, an electrical device 320, an optical device 330, a bonding interconnection 340 and a flat type optical waveguide 350.

The metal block 310 may be a housing wrapping the optical communication module 300. The electrical device 320 is formed on a top surface of the metal block 310 and may adhere to the metal block 310 by a material such as an epoxy 321. The optical device 330 is formed on a top surface of the metal block 310 and may adhere to the metal block 310 by a material such as an epoxy 331. The bonding interconnection 340 can connect the electrical device 320 and the optical device 330.

The flat type optical waveguide 350 may adhere to one side of the metal block 310 by a material such as an epoxy 351. The flat type optical waveguide 350 may be optically aligned with a waveguide of the optical device 330.

A thermal expansion coefficient of the metal block 310 and a thermal expansion coefficient of the flat type optical waveguide 350 may be different from each other. If the thermal expansion coefficient of the metal block 310 and the thermal expansion coefficient of the flat type optical waveguide 350 are different from each other, stress is applied to a connecting piece between the flat type optical waveguide 350 and the metal block 310 and the flat type optical waveguide 350 may optically misaligned with the optical device 330.

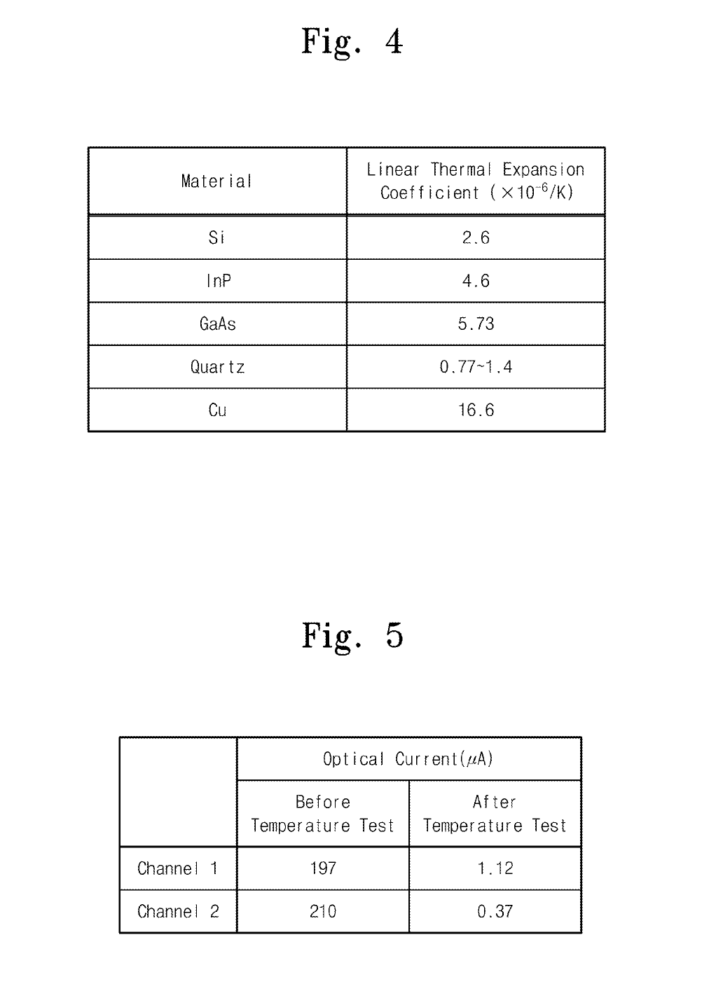

FIG. 4 illustrates thermal expansion coefficients of illustrative materials. Referring to FIGS. 3 and 4, the metal block 310 includes copper (Cu). A thermal expansion coefficient of the copper (Cu) is 16.6. The optical device 330 may include indium phosphorous (InP) or gallium arsenic (GaAs). Thermal expansion coefficients of the indium phosphorous (InP) and gallium arsenic (GaAs) are 4.6 and 5.73 respectively. The flat type optical waveguide 350 may include silicon (Si) or quartz. Thermal expansion coefficients of the silicon (Si) and the quartz are 2.6 and 0.77˜1.4 respectively. Since a difference of thermal expansion coefficient between the metal block 310 and other materials is great, if other materials are attached to the metal block 310, attachment site may be dislocated.

FIG. 5 illustrates a result obtained by measuring a photocurrent of balanced optical receiver including an optical fiber array made by fixing an optical fiber to a silicon optical bench before and after a temperature test is performed. The temperature test is performed using a method of traveling back and forth between −40 degrees centigrade and 80 degrees centigrade twenty times and the total test time is 900 minutes. Referring to FIG. 5, after a temperature test is performed, a photocurrent is greatly reduced. In the optical communication module 300 like FIG. 3, the temperature change causes a dislocation of optical alignment and thereby reliability of optical communication module 300 may be degraded.

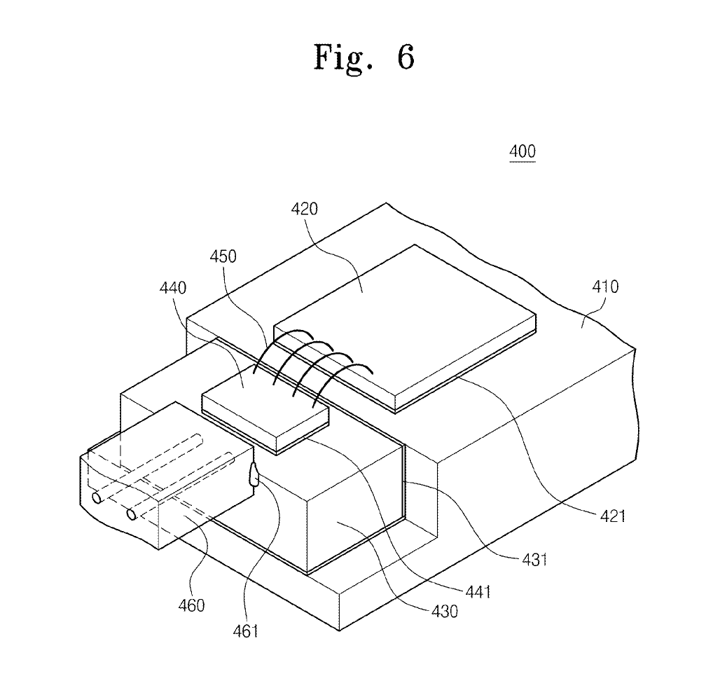

FIG. 6 is an optical communication module 400 in accordance with a first embodiment of the inventive concept. Referring to FIG. 6, the optical communication module 400 includes a metal block 410, an electrical device 420, an optical device adhesive block 430, an optical device 440, a bonding interconnection 450 and a flat type optical waveguide 460.

The metal block 410 may be a housing wrapping the optical communication module 400. The metal block 410 may be used as a ground node of the optical communication module 400. The metal block 410 may have a stair structure including a first top surface and a second top surface lower than the first top surface.

The electrical device 420 is formed on the first top surface of the metal block 410. The electrical device 420 may adhere to the first top surface of the metal block 410 using a conductive material 421 such as a silver epoxy. The electrical device 420 can process an electrical signal being output through the bonding interconnection 450. The electrical device 420 can supply an electrical signal to the optical device 440 through the bonding interconnection 450. The electrical device 420 may include an amplifier, a modulator, a demodulator or a processor.

The optical device adhesive block 430 is formed on the second top surface of the metal block 410. The optical device adhesive block 430 may adhere to the second top surface of the metal block 410 using a conductive material 441 such as a silver epoxy. The optical device 440 may include a waveguide type optical device including an optical waveguide. The optical device 440 can convert an optical signal received from the flat type optical waveguide 460 into an electrical signal and can transmit the converted electrical signal to the electrical device 420 through the bonding interconnection 450. The optical device 440 can receive an electrical signal from the electrical device 420 through the bonding interconnection 450 and can convert the received electrical signal into an optical signal to transmit the converted optical signal to the flat type optical waveguide 460. The optical device 440 can convert an electrical signal being received from the electrical device 420 into an optical signal and can output the converted optical signal to the flat type optical waveguide 460. The optical device 440 may include a photodiode, a laser diode, an optical amplifier, an optical modulator or an optical demodulator.

The bonding interconnection 450 can connect the electrical device 420 and the optical device 440.

The flat type optical waveguide 460 can adhere to one side of the optical device adhesive block 430. The flat type optical waveguide 460 can adhere to the optical device adhesive block 430 using a material 461 such as an ultraviolet hardening epoxy. The flat type optical waveguide 460 may be optically aligned with a waveguide of the optical device 440.

The optical device adhesive block 430 may include a material having the same thermal expansion coefficient as the flat type optical waveguide 460. The optical device adhesive block 430 may have a thermal expansion coefficient having an error within a reference value (for example, 1%, 5%, 10%, etc. of thermal expansion coefficient of the flat type optical waveguide 460) with respect to a thermal expansion coefficient of the flat type optical waveguide 460. The optical device adhesive block 430 may include the same material as the flat type optical waveguide 460. The optical device adhesive block 430 may include silicon (Si) or quartz.

If the thermal expansion coefficient of the optical device adhesive block 430 is the same with the thermal expansion coefficient of the flat type optical waveguide 460, even though a temperature is changed, a stress may not be applied to a connecting piece between the optical device adhesive block 430 and the flat type optical waveguide 460. That is, even though a temperature is changed, the optical communication module 400 maintaining high reliability is provided. Since additional elements such as a mirror or lens are not required and an optical alignment is accomplished by simply combining the flat type optical waveguide 460 with the optical device adhesive block 430, a manufacturing cost of the optical communication module 400 is reduced.

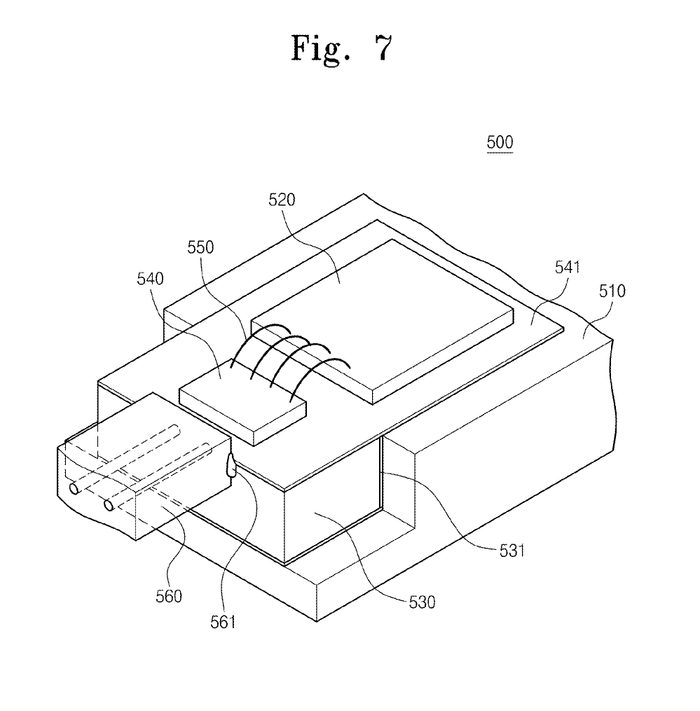

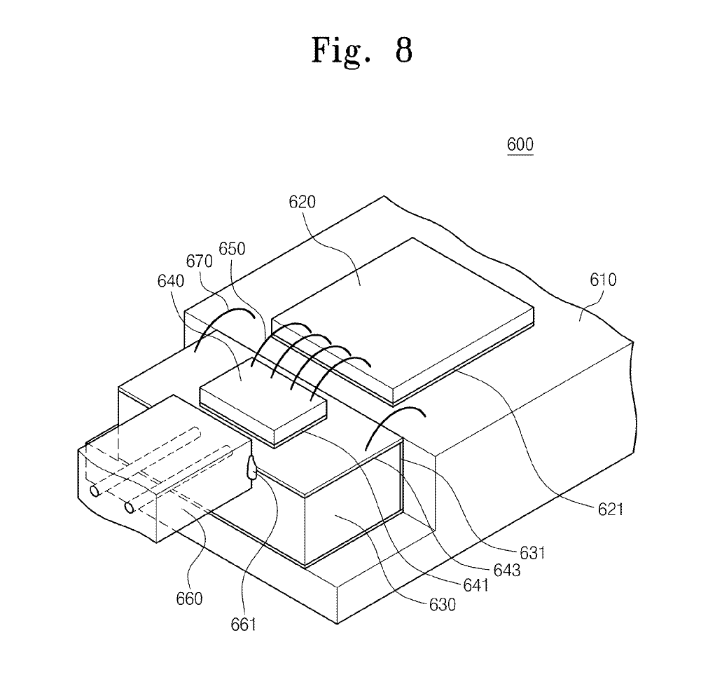

FIG. 7 is an optical communication module 500 in accordance with a second embodiment of the inventive concept. Referring to FIG. 7, the optical communication module 500 includes a metal block 510, an electrical device 520, an optical device adhesive block 530, an optical device 540, a bonding interconnection 550 and a flat type optical waveguide 560.

If comparing the optical communication module 500 with the optical communication module 400 of FIG. 6, a material attaching the electrical device 520 to the metal block 510 and a material attaching the optical device 540 to the optical device adhesive block 530 are connected to each other to form one material 541. The material 541 may include a conductive material such as an epoxy. When the optical device 540 needs a ground node, as illustrated in FIG. 7, the optical device 540 may be connected to the metal block 510 through the material 541 having conductivity such as an epoxy.

FIG. 8 is an optical communication module 600 in accordance with a third embodiment of the inventive concept. Referring to FIG. 8, the optical communication module 600 includes a metal block 610, an electrical device 620, an optical device adhesive block 630, an optical device 640, a bonding interconnection 650 and a flat type optical waveguide 660.

If comparing the optical communication module 600 with the optical communication module 400 of FIG. 6, a metal material 643 is provided on the optical device adhesive block 630. The conductive material 643 may be a material being deposited on a top surface of the optical device adhesive block 630. The optical device 640 adheres onto the metal material 643 using a conductive material such as a silver epoxy. The conductive material 643 is connected to the metal block 610 through an interconnection 670. If the optical device 640 needs a ground node, as illustrated in FIG. 8, the optical device 640 may be connected to the metal block 510 through the conductive material 643 and the interconnection 670.

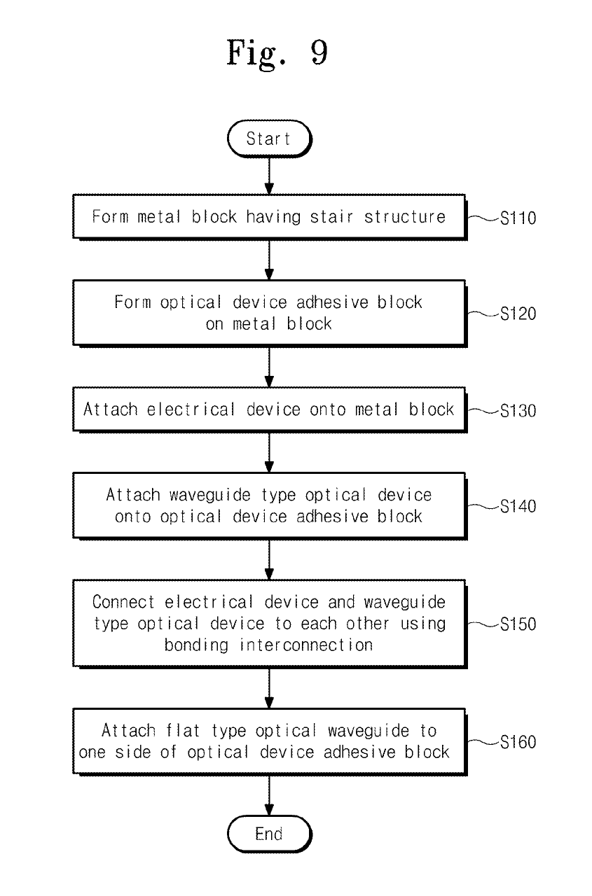

FIG. 9 is a flowchart illustrating a manufacturing method of optical communication module in accordance with some embodiments of the inventive concept. Referring to FIG. 9, in S110, a metal block having a stair structure including a first top surface and a second top surface lower than the first top surface is formed.

In S120, an optical device adhesive block is formed on the second top surface of the metal block. In S130, an electrical device adheres onto the first top surface of the metal block. In S140, a waveguide type optical device adheres onto a top surface of an optical device adhesive block. In S150, the electrical device and the waveguide type optical device are connected to each other using a bonding interconnection. After that, in S160, a flat type optical waveguide adheres to one side of the optical device adhesive block.

According to some embodiments of the inventive concept, a waveguide type optical device is formed on a block having the same thermal expansion coefficient as a flat type optical waveguide and the flat type wave guide is combined with the block without separate constituent elements. Therefore, an optical communication module having a reduced manufacturing cost and improved reliability and a method of manufacturing the optical communication module are provided.

The foregoing is illustrative of the inventive concept and is not to be construed as limiting thereof. Although a few embodiments of the inventive concept have been described, those skilled in the art will readily appreciate that many modifications are possible in the embodiments without materially departing from the novel teachings and advantages of the present invention. Accordingly, all such modifications are intended to be included within the scope of the present invention as defined in the claims. The present invention is defined by the following claims, with equivalents of the claims to be included therein

What is claimed is:

1. An optical communication module comprising:
a metal block:
an electrical device formed on the metal block;
an optical device adhesive block formed on the metal block;
an optical device formed on the optical device adhesive block and connected to the electrical device through a bonding interconnection; and
a flat type optical waveguide formed on one side of the optical device adhesive block and optically aligned with the optical device.

2. The optical communication module of claim 1, wherein the flat type optical wave guide adheres to one side of the optical device adhesive block.

3. The optical communication module of claim 2, wherein the flat type optical waveguide adheres to one side of the optical device adhesive block using an ultraviolet hardening epoxy.

4. The optical communication module of claim 1, wherein the optical device adhesive block comprises a material having a thermal expansion coefficient having a difference within a reference value with respect to a thermal expansion coefficient of the flat type optical waveguide.

5. The optical communication module of claim 1, wherein the optical device adhesive block comprises the same material as the flat type optical waveguide.

6. The optical communication module of claim 1, wherein the optical device adheres to the optical device adhesive block using a first conductive material and the electrical device adheres to the metal block using a second conductive material.

7. The optical communication module of claim 6, wherein the first conductive material and the second conductive material are connected to each other.

8. The optical communication module of claim 6, wherein the first conductive material is connected to the metal block through an interconnection.

9. The optical communication module of claim 6, wherein each of the first conductive material and the second conductive material comprises a silver epoxy.

10. The optical communication module of claim 6, further comprising a metal plate formed on the optical device adhesive block, wherein the optical device adheres onto the metal plate using the first conductive material and the metal plate is connected to the metal block through an interconnection.

11. The optical communication module of claim 1, wherein the optical device comprises a waveguide type optical device and a waveguide of the optical device is optically aligned with the flat type optical waveguide.

12. The optical communication module of claim 1, wherein the metal block has a stair structure including a first top surface and a second top surface lower than the first top surface,
wherein the electrical device is formed on the first top surface of the metal block, and
wherein the optical device adhesive block is formed on the second top surface of the metal block.

13. The optical communication module of claim 12, wherein the first top surface of the metal block and a top surface of the optical device adhesive block are aligned with each other.

14. A method of manufacturing an optical communication module comprising:
forming a metal block having a stair structure including a first top surface and a second top surface lower than the first top surface;
forming an optical device adhesive block on the second top surface of the metal block;
attaching an electrical device on the first top surface of the metal block;
attaching a waveguide type optical device on the top surface of the optical device adhesive block;
connecting the electrical device and the waveguide type optical device to each other using a bonding interconnection; and
attaching a flat type optical waveguide on one side of the optical device adhesive block,
wherein the flat type optical waveguide is optically aligned with a waveguide of the waveguide type optical device.
